(19) United States
(12) Patent Application Publication
(10) Pub. No.: US 2016/0035151 A1
(43) Pub. Date: Feb. 4, 2016

(54) Method and Apparatus for Vehicle Data Gathering and Analysis

(71) Applicant: Ford Global Technologies, LLC, Dearborn, MI (US)

(72) Inventors: Douglas James McEwan, Royal Oak, MI (US); Christopher Paul Glugla, Macomb, MI (US); Michael Damian Czekala, Canton, MI (US); Garlan J. Huberts, Milford, MI (US)

(21) Appl. No.: 14/448,259

(22) Filed: Jul. 31, 2014

(51) Int. Cl. G07C 5/00

(52) U.S. Cl. CPC G07C 5/008

(57) ABSTRACT

A system includes a processor configured to receive identification of a vehicle system-usage parameter. The processor is also configured to receive identification of a vehicle model in which to track the parameter. Further, the processor is configured to transmit the parameter to wirelessly connected vehicles of the identified model. The processor is additionally configured to receive usage-related tracking data corresponding to the parameter from the wirelessly connected vehicles. The processor is also configured to determine if usage-related tracking data indicates usage below a predefined threshold and report determined usage-related tracking data when the usage is below the threshold.

### TECHNICAL FIELD

The illustrative embodiments generally relate to a method and apparatus for vehicle data gathering and analysis.

### BACKGROUND

Connected vehicle services provide a wide variety of customer benefits through wireless communication to and from the vehicle. Navigation, infotainment, advertisements and even recall notices can be received on-demand. Since the communication can be two way, customer vehicles can also be used for data-gathering purposes across a variety of fields.

For example, U.S. Application 2014/0040434 generally relates to systems, methods, and related computer programs, wherein vehicle operation data is extracted from an internal automotive network. A system for enabling the generation and sharing of vehicle operation data via a computer network includes a data harvesting device connected to an information system of a vehicle, the data harvesting device capturing vehicle information from the vehicle and processing the vehicle information to generate current vehicle operation data; and a computer system in communication with the data harvesting device, the computer system including one or more server computers connected to a computer network. The data harvesting device connects to the computer system on an intermittent basis via a wireless network. The computer system includes a database system for logging the current vehicle operation data. The computer system is configured to act as an information gateway for provisioning the current vehicle operation data to one or more remote server computers in communication with the computer system. The computer system is also operable to enable the sharing of vehicle operation data and related information via social networks.

### SUMMARY

In a first illustrative embodiment, a system includes a processor configured to receive identification of a vehicle system-usage parameter. The processor is also configured to receive identification of a vehicle model in which to track the parameter. Further, the processor is configured to transmit the parameter to wirelessly connected vehicles of the identified model. The processor is additionally configured to receive usage-related tracking data corresponding to the parameter from the wirelessly connected vehicles. The processor is also configured to determine if usage-related tracking data indicates usage below a predefined threshold and report determined usage-related tracking data when the usage is below the threshold.

In a second illustrative embodiment, a system includes a processor configured to receive identification of a geographic area in which to track vehicle usage. The processor is also configured to receive location data from a plurality of vehicles, wirelessly connected to the processor, that travel within the predefined area. The processor is further configured to determine sub-areas, within the predefined area, of vehicle concentration above a predefined threshold and report the sub-areas as recommended refueling points.

In a third illustrative embodiment, a system includes a vehicle-based processor configured to wirelessly receive, from a remote system, a system-parameter and user-demographic for tracking The processor is also configured to determine when a vehicle system defined by the system-parameter is used. Further, the processor is configured to determine the user-demographic for vehicle occupants when the vehicle system is used and wirelessly report, to the remote system, usage data and user-demographic data for when the vehicle system is used.

### BRIEF DESCRIPTION OF THE DRAWINGS

FIG. 1 shows an illustrative vehicle computing system;

FIG. 2 shows an illustrative process for data gathering;

FIG. 3 shows an illustrative process for data analysis and reporting; and

FIG. 4 shows another illustrative process for data analysis.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

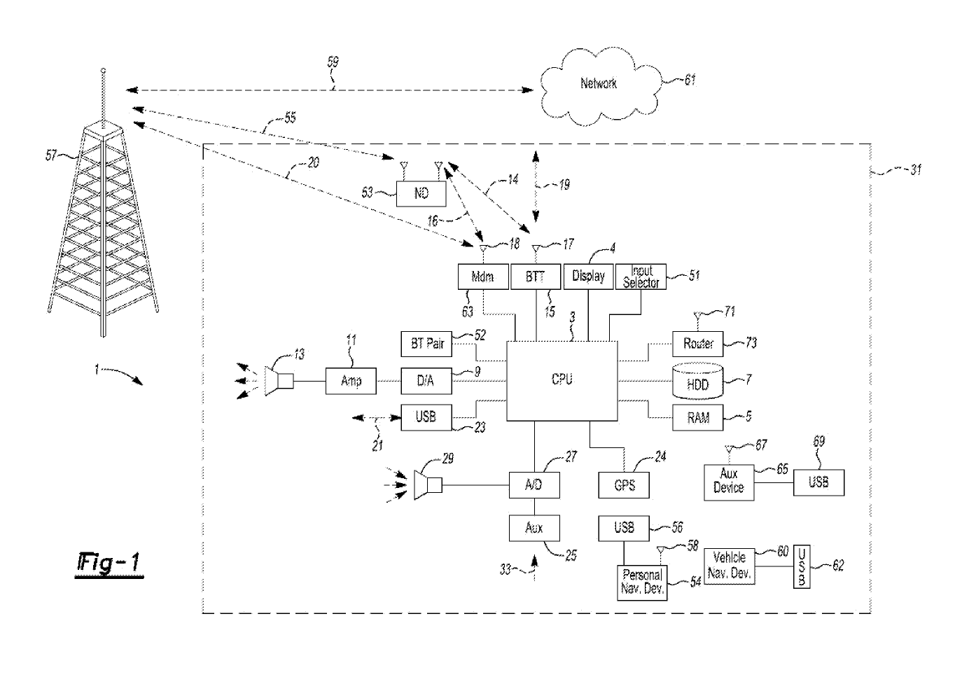

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

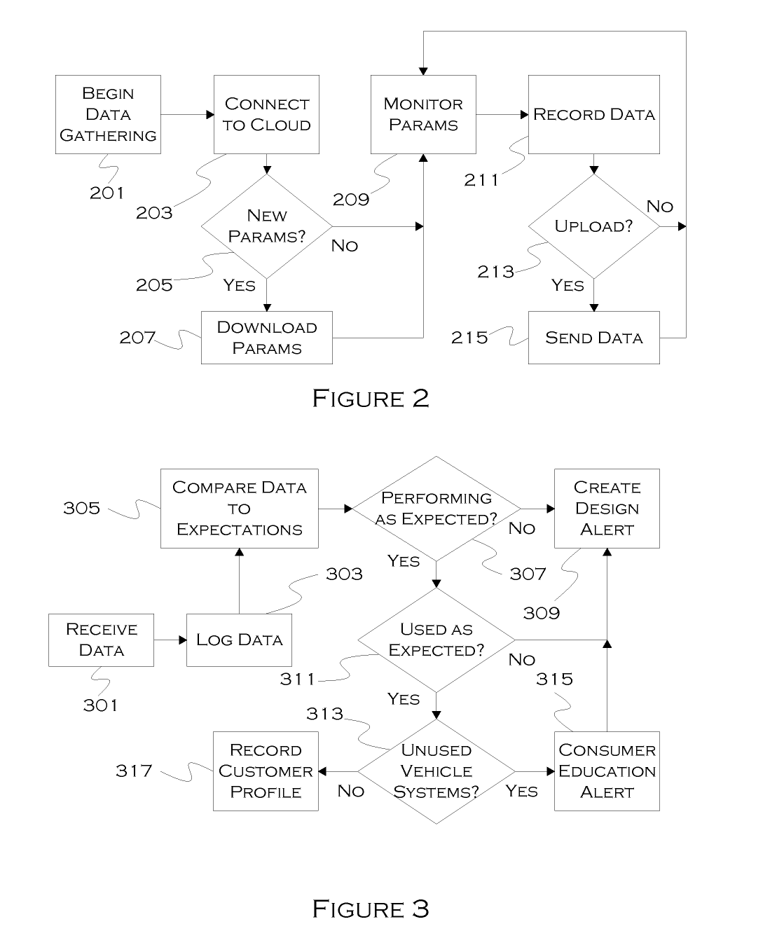

FIG. 2 shows an illustrative process for data gathering. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative embodiment, the process runs on a vehicle system that can gather vehicle data and report the data to a remote server, such as an OEM server. In this example, the process begins data gathering 201. Since different data may be needed at different times, or new data may be identified for gathering, the process connects to a remote resource, such as the cloud 203. When the connection is established, the process can check for any new data parameters to be gathered 205.

Since the data gathering is specific to each vehicle, there may be certain data that is desirable for particular makes and models. Using the data gathering process, the system can gather the data from each vehicle as appropriately specified by the OEM system. Any relevant data parameters can be downloaded 207.

Once all parameters (existing and new) have been established, the process can monitor the appropriate vehicle systems 209. As the systems are monitored, the relevant data can be recorded 211. This data can reside on the vehicle system until transfer to an OEM server is appropriate. The data can include, but is not limited to, vehicle speeds, fuel data, weather data, traffic data (recognizable, for example, by stop and go movement), acceleration/deceleration data and any other relevant data that may be useful in identifying vehicle problems.

Once the data is ready for upload, which may be periodically or continuous as the data is gathered 213, the process can package and send the relevant data for remote storage and analysis. Using this data, gathered from any number of vehicles on the road, an OEM can analyze driver types and driving behavior. Among other things, this information can be used to suggest refueling/recharging locations, used to target new customer groups based on observed purchasing behavior, propose changes to vehicle systems based on observed user groups, etc.

FIG. 3 shows an illustrative process for data analysis and reporting. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, actual vehicle usage is examined and compared to expected vehicle usage to determine, for example, possible design changes and/or demographic end-users. For example, if a certain sport utility vehicle was spending more time on trails and in “rough” terrain than expected, changes to the design might be warranted. Similarly, if a vehicle was targeted at 50-somethings, and 30-somethings were buying the vehicle in unexpected quantities, changes to the vehicle and/or marketing approaches might be warranted. Also, utilization of vehicle features can be tracked to know what people want/use, and what people don't want or maybe just don't know about. For example, automatic moonroofs may be used 70% of the time in certain weather, providing useful information about the desirability of that feature and about in what climates it should be pushed hardest as an upgrade. At the same time, it may be the case that only 5% of users utilize user-selectable traction control, leading to an opportunity to educate owners about the feature. Following sufficient education, if owners still don't use the feature, this feature may be dropped as a standard feature from future vehicles as an unneeded cost.

This illustrative non-limiting process focuses on data gathering and analysis related to vehicle and vehicle feature use. The data gathered, for example, in the process shown in FIG. 2 is received by the process 301. This data is logged in the appropriate database(s) for later retrieval if desired. There can be multiple databases for logging, one, for example, that applies to all vehicles of a certain make/model. Another can be owner specific, so that general and specific user profiles can be created and examined.

Once the vehicle use and vehicle feature use data is gathered, it can be compared to expectations. For example, without limitation, data relating to vehicle use can include, but is not limited to: types of driving (highway, city, offroad, etc.); times of use; days of use (is this a “weekend recreational” vehicle; average speeds; acceleration profiles (do users of this vehicle demonstrate a cautious approach to driving, which could indicate more safety features should be profiled, or do they demonstrate an aggressive approach, which could lead to addition/profiling of more “fun” driving experience features); demographics of drivers/passengers; number of passengers; duration/distance of trips; range of use; and any other useful vehicle use data.

At the same time, vehicle feature use data can be compared to expectations. For any number of select vehicle features (set by parameters for data-gathering, for example) or for all vehicle features, data can be gathered. This can include, for example, without limitation: window states; heating/ventilation/air conditioning (HVAC) states; radio usage (same station constantly, volume levels, types of music, etc.); navigation usage; used/unused seating settings (heated/cooled seats, ranges of used seat settings (including attempts to adjust a seat in a certain direction beyond the permitted range)); steering wheel positioning; wiper usage; and any other user utilizable features that may/may not be used at the driver/occupant's discretion).

All of the determined data can then be compared to any baseline expectations for a given vehicle or vehicle feature 305. For example, it may be observed that when a single occupant is in a vehicle, a radio is used 95% of the time, but only 1-2 stations are used. When two occupants or more are present, a radio may be used only 80% of the time, but 4-6 stations may be used. This could lead to a decision to push satellite radio in vehicles where it is observed that multiple parties are commonly present. Even user-specific advertising can be created, targeting specific profiles having over N % multiple occupancy.

Also, using the baseline expectations, it may turn out that a certain vehicle is being purchased by users outside an expected demographic, or that a feature is not being used, either in general or by the expected users. With respect to the first concept, a vehicle could have been built with a target audience of 30-34 year olds, but could be purchased most commonly by 45-49 year olds. Knowing this, the manufacturer can either push the 45-49 year old market further by including features known to be desirable to those users (which can actually also be determined by the data gathering process), or, for example, can retool the vehicle to focus more on features desired by the intended target market.

Since the data comes in from a high volume of sources, it may also be observed that the vehicle is used by the target demographic in one region of the country, and a different demographic in another region. This could lead to a creation of two vehicle classes, each variant focused more on the observed demographic, hopefully leading to greater penetration in obtained markets as well as new penetration in the regions where the vehicle was not previously selling to the alternative demographic.

Similarly with features, use of “standard” features can be observed to determine the most desirable features and those which might be left out of future design decisions. Also, certain performance minimums can be examined with the data. For example, if a vehicle is not accelerating appropriately in cold/icy conditions, the engineers can re-evaluate the systems that facilitate traction and power delivery to improve this in future models. Without this information, it may take much longer to realize opportunities for vehicle system improvement.

Expectations can be set by the manufacture with respect to any aspect of the gathered data, and they can also be adjusted dynamically as data comes in, to track continuity in observed behavior (does the vehicle slowly meet a shifting expectation over time, leading to meaningful observations, or was an initial observation an outlier, and does the data shift back towards original expectations).

If a vehicle or vehicle system (analysis can be done on any number of appropriate scenarios) is not performing as expected 307, the process can identify an opportunity for a design change 309. This could, for example, send an automatic notification to the engineers responsible for a given vehicle or vehicle system.

Similarly, if a vehicle or vehicle system is not being used as expected 311, opportunities for design or marketing changes might be identified. Again, notification can be automatically generated and populated to the appropriate engineers/marketers/etc.

At the same time, if a vehicle system is being unused by a consumer 313, it may simply be because the consumer does not understand or even know about the vehicle system. This can generate an opportunity for a consumer education moment 315. For example, a consumer may not know that different traction control can be set manually in different weather. After observing very low usage rates, or possibly simply after observing a low or zero usage rate for an individual, the process may offer a tutorial on the system (assuming such a tutorial exists). If the tutorial does not exist, but the overall usage rate is low, the appropriate OEM party may be notified to create such a tutorial.

Additionally or alternatively, the OEM may consider whether or not to even include the feature in later vehicles, especially if usage rate remains low after users view the tutorial. On the other hand, if, after viewing the tutorial, usage rate increases, the OEM can instruct dealers to fully explain the feature to customers, to improve the customer experience right from the start.

Once all appropriate analysis has been performed, customer profile information can be created/recorded and any appropriate demographic information can be updated or added as needed. The customer profile information can include customer specific data useful in identifying opportunities to automatically improve a specific customer's driving experience (e.g., without limitation, targeted marketing, tutorials, recall notifications, etc.). When a vehicle life or lease nears an expected end, this information can also be used to suggest new models that may be desirable for the customer, based on observed behavior and usage over the life of the vehicle.

For example, if a customer always used heated/cooled seats, always used satellite radio, frequently had four or more people in the vehicle, commonly used a moon roof, and had a cautious driving style, the process may recommend a custom configured new vehicle based on all the observed desirable features. Before ever visiting a dealer or website, the customer could be presented with one or more new vehicle options that met some, most or all of the observed likely needs of the customer, which would likely greatly increase retention.

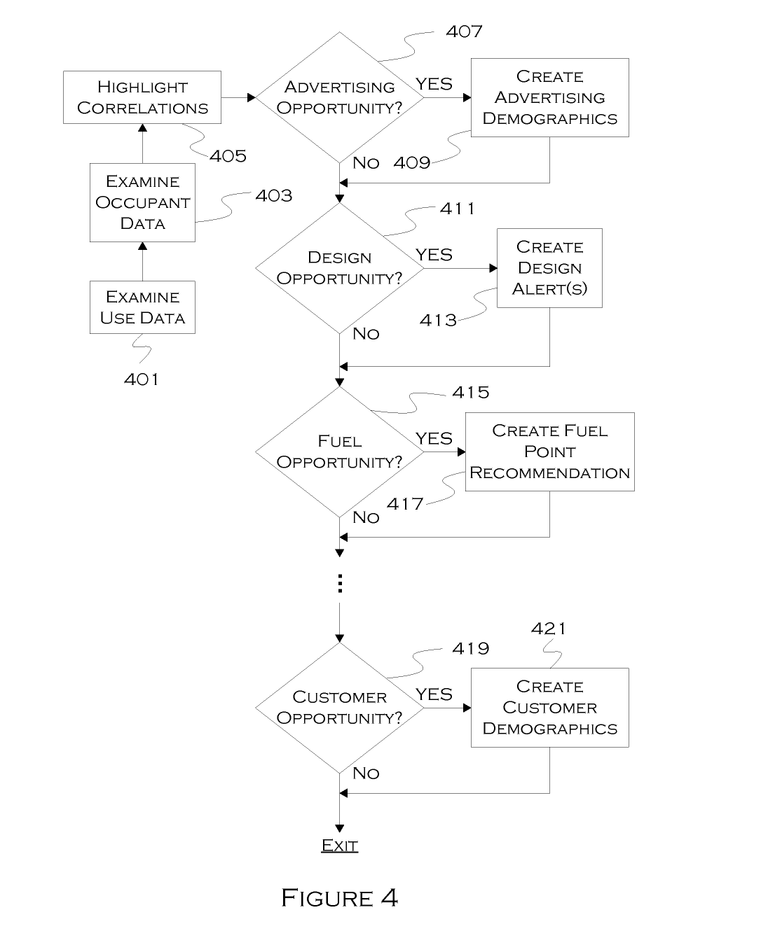

FIG. 4 shows another illustrative process for data analysis. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, use and occupant data are compared an analyzed to provide insights into demographic use of vehicles and features. Again, the data utilized is data gathered from a plurality of vehicles. While examples of various identified opportunities relate to group data, similar opportunities exist on a user-by-user basis for many of the types of analysis. Since digitally tailored advertising and offers can be user-specific, there is nothing to prevent this process or a similar process from being utilized on a user-by-user level.

In this example, both use data 401 and occupant data 403 are retrieved. In this example, use and occupant data are associated on a vehicle-by-vehicle basis, such that use data for a given vehicle also includes occupant data for those uses. This allows the examination of “who” is providing the uses of a given feature/vehicle. Occupant and use data is retrieved for a large number of vehicles. The data may, but is not required to, correspond with makes, models, user classes (e.g., demographic groups) or any other aspect that is to be examined. For example, if the use of alternative manual paddle shifting in automatic vehicles is to be examined across all demographic classes, then all data relating to paddle shifting and corresponding user data could be pulled. In another example, this data may only be examined with respect to a particular vehicle, or demographic class. Or, for example, data relating to 30-34 year old users could be pulled to see which features those users are utilizing.

Since the data can be sorted by any aspect of vehicle, vehicle feature, user demographic, etc., it can have widespread use across a variety of solutions. A number of non-limiting examples of such uses are shown with respect to this process. Such a process could be run with respect to any aspect of the data, and repeated for varied aspects of data to obtain a comprehensive analysis of new opportunities across a variety of fronts.

User demographic data gathering capability may be limited based on information available to the vehicle. For example, if user phones are present with user profiles associated therewith, it may be possible to know specific demographic information about users present when a system is used. On the other hand, vehicle systems may be needed to roughly identify users. Ages may be difficult to determine in this manner, although the presence of children or no children can typically be determined at least by vehicle weight sensors. If requested demographic information is not present, additional information may be gathered so that basic assumptions about a demographic can be made. For example, without limitation, if statistical information indicates that a certain percentage of listeners to a particular radio station are of a certain age or sex, then reporting a radio station being listened to when a system is used will give at least a statistical likelihood that the user meets the demographics of the radio station's listeners. The demographic can even be discounted to account for the radio station (or other similar) demographics.

For example, if five instances of users of a system are tracked, and three are known to be men, and one is known to be a woman, and for the fifth case, no gender is known, but it is known that a station tuned in and playing that has a 65% female listening audience, then the final count of men and women can be 3.35 and 1.65, treating the unknown as a mixed-gender entity having genders in equal part according to the listening demographic. Similar “partial” demographics can be gathered with respect to age. Height and/or weight (as gathered by vehicle sensors), for example, can be used in a similar manner to gather partial demographics when precise data is unavailable.

One type of analysis that could be performed is to generate advertising opportunities. Data demonstrating that a certain vehicle or vehicle feature is desirable to a certain demographic could be used to tailor advertisements and inspire new advertising campaigns to further target that demographic. If an advertising opportunity is identified 407 (which, in this example, is a correlation between use and demographic data 405), the process could create suggested demographics and correlate vehicle makes, models and or features to those demographics.

So, for example, in one instance all data on LINCOLN NAVIGATORS could be pulled. The data may represent that the typical owner is either 35-39 or 49-54. Among 35-39 year olds, it may be that the most used features include satellite radio and onboard navigation. Among 49-54 year olds, the most used features could be automatic liftgate and heated/cooled seats. Also, it may be observed that the majority of 34-39 year olds buy a cheaper class of NAVIGATOR.

The process, identifying these correlations, could present the demographics and the correlations for use by advertisers. So when planning an advertisement to target 34-39 year olds, or for the cheaper NAVIGATOR, it would be known that highlighting satellite radio options and onboard navigation options will generate interest. When planning an advertisement to target 49-54 year olds, it will be known that highlighting automatic lift gates and heated/cooled seats will be likely generate interest. If LINCOLN desires to move 34-39 year olds to the next higher class of vehicle, then it is known that advertising the higher class NAVIGATOR with satellite radio options and onboard navigation options might generate interest in moving up.

Since the data can be sampled from all vehicles on the road, if desired, real, meaningful usage data can be gathered and analyzed. Such data is potentially far more useful than, for example, survey data gathered at random from a random sample, even if the sample if from actual users. The data is also far more comprehensive.

In another example, a design opportunity may be discovered based on the correlation. For example, using the non-limiting NAVIGATOR example above, it may be desired to get further penetration into the 49-54 year old market. But some customers may not be able to afford the class of vehicle in which heated/cooled seats are standard, so that may be added as an option to a lower class of vehicle, or even as a standard feature. Or, for example, it may be observed that people in colder climates don't use cooled seats frequently, so the feature can be removed from a standard build to save costs. In other examples, the feature can be redesigned to encourage more use. It may be the case that features having lit buttons associated therewith have more use than features having unlit buttons, so a feature which is highly desirable but little utilized may be redesigned to be more obvious to the users.

Performance of features can also be evaluated and design opportunities can be presented. If a design opportunity is observed based on a correlation of feature use/non-use or performance/non-performance with a certain vehicle or demographic 411, a design alert may be generated and/or sent to the appropriate parties 413.

Another example could be the analysis of vehicle utilization data with respect to a region. Points of high traffic (determined by geographic location utilization data) can be identified for a given region based on the gathered vehicle data. This can help identify where to place a refueling/recharging point (such as a commonly traveled road or intersection).

Since electric vehicles are still fairly uncommon, it may be more difficult to determine the appropriate location for charging stations. If two thousand people in an area of fifty thousand people use electric vehicles, it would be desirable to place one or more charging stations in locations that are commonly traveled by the electric vehicle owners. Pulling location-based utilization data may show that fourteen hundred of the vehicles pass one location at least once a week, and three hundred of the vehicles pass a second location. So this would suggest that instead of a single, central station for the region, it may be desirable to build a large station at the first point and a smaller charging station at the second point.

Alternatively, usage may be somewhat evenly distributed so that no areas of high commonality are found. In such a case, a centralized (which can be centralized with respect to weighted usage/location data, or simply geographic data) station may be the best option. If geographic correlations or non-correlations are identified with respect to location-based usage data 415, the process may identify one or more charging point locations 417. A similar process can be used with respect to gasoline or diesel refueling points if desired.

Thresholds can be set above which to determine vehicle concentration. If no thresholds are met, areas of highest concentration can be examined. For example, a threshold of 30% may be set, and no one area (road/intersection) may result in identification of 30% of the vehicles passing through that area within a given timeframe. Subsequently, one or more areas of highest concentration may be determined. While “highest” would typically identify only a single location, several areas may be close enough (within a tolerance) in percentage of travel that the system will classify all those areas as “highest.” Additionally or alternatively, the system may be instructed to identify a predetermined number of areas of highest concentration, and thus take the number of areas corresponding to the predetermined number having the highest concentration.

New customers for existing vehicle lines may also be identified from a data analysis. For example, without limitation, it could be observed that 23-27 year olds prefer mid-sized vehicles with power seats, onboard navigation and that have at least 245 horsepower. A current vehicle model may have power seats and onboard navigation, but may only have 215 horsepower. The process can use correlations between features within a demographic group and existing vehicles to identify possible new customers 419. Changes can be suggested that might make the vehicle more desirable, based on features lacking in the current underpurchased vehicle 421. In another example, merely identifying a new customer class may be sufficient 421, and may generate new inspiration to advertise to the identified demographic.

Numerous examples of data analysis and generated results are considered to be within the scope of this disclosure. By gathering use, location, feature-use, demographic data and other data described or similar to data described herein, countless opportunities for improvement across the entire field of automotive manufacturing, distribution and support can be identified.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive identification of a vehicle system-usage parameter;
receive identification of a vehicle model in which to track the parameter;
transmit the parameter to wirelessly connected vehicles of the identified model;
receive usage-related tracking data corresponding to the parameter from the wirelessly connected vehicles;
determine if usage-related tracking data indicates usage below a predefined threshold; and
report determined usage-related tracking data when the usage is below the threshold.

2. The system of claim 1, wherein the vehicle model also includes a vehicle make.

3. The system of claim 1, wherein the parameter includes both a user demographic to track and a vehicle system to track.

4. A system comprising:
a processor configured to:
receive identification of a geographic area in which to track vehicle usage;
receive location data from a plurality of vehicles, wirelessly connected to the processor, that travel within the geographic area;
determine sub-areas, within the geographic area, of vehicle concentration above a predefined threshold; and
report the sub-areas as recommended refueling points.

5. The system of claim 4, wherein the sub-areas include an intersection identification.

6. The system of claim 4, wherein the sub-areas include a road identification.

7. The system of claim 4, wherein the processor is further configured to determine one or more areas of highest vehicle concentration, if the predefined threshold is not met.

8. The system of claim 7, wherein the processor is configured to receive a number of areas of highest concentration and determine a number of areas of highest vehicle concentration based on the received number.

9. The system of claim 7, wherein the processor is configured to receive a minimum concentration threshold and if the minimum concentration threshold is not met, to report a centralized location as a recommended refueling point.

10. The system of claim 9, wherein the centralization is based on reported vehicle locations, such that the centralized location corresponds to a location having a highest percentage of vehicles reported.

11. The system of claim 9, wherein the centralization is based on a center of the geographic area.

12. A vehicle-based processor configured to:
wirelessly receive, from a remote system, a system-parameter and user-demographic for tracking;
determine when a vehicle system defined by the system-parameter is used;
determine the user-demographic for vehicle occupants when the vehicle system is used; and
wirelessly report, to the remote system, usage data and user-demographic data for when the vehicle system is used.

13. The system of claim 12, wherein the user-demographic includes age.

14. The system of claim 13, wherein the age is an age range.

15. The system of claim 12, wherein the user-demographic includes gender.

16. The system of claim 12, wherein the user-demographic includes number of occupants.

17. The system of claim 12, wherein the user-demographic is determined based on predefined user profiles associated with user-devices detected as present within a vehicle.

18. The system of claim 12, wherein the processor is further configured to report secondary demographic-associated data, if the user demographic is not determinable.

19. The system of claim 18, wherein the secondary demographic data includes a user height or weight as determined by a vehicle sensor.

20. The system of claim 18, wherein the secondary demographic includes a current playing radio station or music selection.
